(19) United States
(12) Patent Application Publication
(10) Pub. No.: US 2013/0340024 A1
(43) Pub. Date: Dec. 19, 2013

(54) APPARATUS FOR EXTENDING HDMI SIGNAL TRANSMISSION

(71) Applicant: PHASEHD INC., Burlington (CA)

(72) Inventor: John MACDOUGALL, Burlington (CA)

(73) Assignee: PHASEHD INC., Burlington (CA)

(21) Appl. No.: 13/910,595

(22) Filed: Jun. 5, 2013

Related U.S. Application Data
(60) Provisional application No. 61/659,871, filed on Jun. 14, 2012.

(51) Int. Cl. H04N 7/10

(52) U.S. Cl. CPC H04N 7/102
USPC 725/127

(57) ABSTRACT

An apparatus for extending HDMI signal transmission. The apparatus comprises a transmit module and a receive module isolating a native HDMI/DVI cable of indeterminate length and are capable of enabling a relatively long native HDMI/DVI cable to comply with the HDMI specification. The modules each have DC blocks, low speed blocks and high speed blocks and interface with HDMI source and sink devices to maintain HDMI compliance.

### CROSS REFERENCE

This application claims priority to U.S. patent application No. 61/659,871, filed Jun. 14, 2012, which is incorporated herein by reference.

### TECHNICAL FIELD

The following relates generally to video signal transmission and more specifically to extending the operable cable length for HDMI signal transmission.

### BACKGROUND

High definition multimedia interface (HDMI) is a commonly used video (and accompanying audio) signal standard. The HDMI standard defines electrical compliance characteristics for devices and cables. Due to the need to accommodate low and high speed signals transmitted by an HDMI cable, compliant cables tend to be relatively short. With the inception of 4K video standards, the high-speed signal bandwidth requirements double and inversely, the overall distance capabilities are reduced by approximately half.

HDMI compliance mandates that the DDC (SCL and SDA) and CEC wires must not exceed an overall capacitance of 700 pF which effectively translates to a maximum of approximately 10 m of passive HDMI/DVI cable. A key failure mechanism is caused by excessive capacitance. Capacitance affects the rise and fall times of the low frequency signals due to the low pass filtering nature incumbent upon long reach cables thus making it difficult for the source and display devices to properly interpret the data. This results in errors such as periodic white screen flashes (pseudo random noise), OSD error messages, loss of signal, sub-optimal resolution and loss of CEC functionality. Other errors caused by non-compliant cables include non-start-up errors, audio glitches, video sparkles, intermittent video, loss of sync and/or a complete loss of signal.

Native long length HDMI/DVI cables are commonly found in commercial, industrial and consumer installations to transport uncompressed data between a source and display. To reach longer distances a display-end signal booster is often needed to recover the signal. However, these boosters may not maintain compliance as they may not isolate excessive capacitance within the long reach HDMI/DVI cable for low-speed blocks.

Another option is non-native category cable extenders, such as CAT5e, CAT6 and CAT6a. However, these options may not have adequate bandwidth to support 4K signals.

### SUMMARY

In one aspect, an apparatus for extending HDMI signal transmission is provided, said apparatus comprising: (a) a transmit module comprising a transmit-side DC block, a transmit-side high speed block and a transmit-side low speed block, said transmit module capable of being coupled to an HDMI source device and communicating therewith in compliance with the HDMI specification; and (b) a receive module comprising a receive-side DC block, a receive-side high speed block and a receive-side low speed block, said receive module capable of being coupled to an HDMI sink device and communicating therewith in compliance with the HDMI specification; said transmit module and receive module capable of being coupled to one another and communicating with one another to mitigate effects of long reach HDMI cabling.

In another aspect, a method for extending HDMI signal transmission is provided, said method comprising enabling the isolation of DC, low-speed and high-speed signals of an HDMI cable using a transmit module coupled to a first end of said HDMI cable and a receive module coupled to a second end of said HDMI cable, said transmit module comprising a transmit-side DC block, a transmit-side high speed block and a transmit-side low speed block, said transmit module capable of being coupled to an HDMI source device and communicating therewith in compliance with the HDMI specification, and said receive module comprising a receive-side DC block, a receive-side high speed block and a receive-side low speed block, said receive module capable of being coupled to an HDMI sink device and communicating therewith in compliance with the HDMI specification; said transmit module and receive module mitigating effects of long reach HDMI cabling.

### BRIEF DESCRIPTION OF THE DRAWINGS

The features of the invention will become more apparent in the following detailed description in which reference is made to the appended drawings wherein:

FIG. 1 is a block diagram of a transmit circuit and a receive circuit for an HDMI extender apparatus;

FIG. 2 is an illustration of an HDMI extender apparatus connected to a long reach HDMI cable in another embodiment;

FIG. 3 is a functional block diagram generally illustrating the principal operative components of an electrical design implementation of the DC power component of the transmit powered embodiment of the present invention.

FIG. 4 is a functional block diagram generally illustrating the principal operative components of an electrical design implementation of the low-speed component of an embodiment of the present invention.

FIG. 5 is a functional block diagram generally illustrating the principal operative components of an electrical design implementation of the high-speed component of an embodiment of the present invention.

FIG. 6 is a diagram illustrating alternative physical iterations of embodiments in accordance with the present invention.

### DETAILED DESCRIPTION

Embodiments will now be described with reference to the figures. It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

The following provides an apparatus for extending HDMI signal transmission. The apparatus comprises a transmit module and a receive module isolating a native HDMI/DVI cable of indeterminate length and are capable of enabling a relatively long native HDMI/DVI cable to comply with the HDMI specification. In an example for a specific HDMI/DVI cabling of 26 AWG, the apparatus may be operable to enable HDMI signal transmission in the range of 5 m to 40 m in cable length, or more. Compliance with the HDMI specification results in fewer errors during communication and increased device interoperability.

The HDMI/DVI connection specification comprises three portions: a DC portion (+5V and HPD signals), low-speed portion (SDA, SCL, CEC and Utility signals and high-speed portion (TMDS Data and TMDS Clock signals). The transmit module and receive module isolate the passive HDMI/DVI cable and actively intervene with all three of the portions which, in conjunction with even a substantially long native passive HDMI/DVI cable coupled therebetween, provides cable equalization and signal retiming to minimize the impact of interoperability related failures.

The transmit module is coupled between the output of a source device and the passive cable, and is capable of optimizing transmitted signals' launch swing and output jitter so as to be suitable for long reach transmission. The receive module is capable of recovering the signal despite the negative effects on the signal caused by the intermediary cable, which may be long reach.

Both the transmit module and receive module comprise low-speed buffering devices, isolating excessive capacitive load of the DDC and CEC wires of the cable to minimize low-speed related failures.

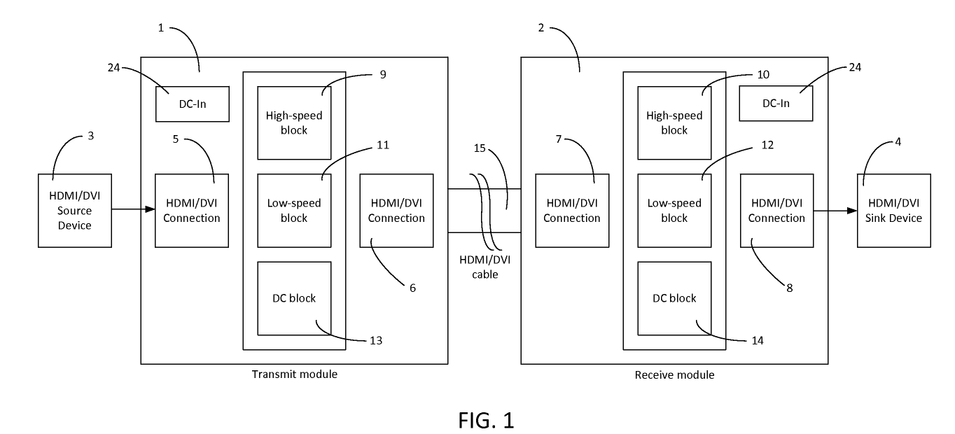

Referring first to FIG. 1, the apparatus comprises a transmit module (1) and a receive module (2). The transmit module (1) comprises a transmit-side input HDMI/DVI connection (5), a high-speed block (9), a low-speed block (11), a DC block (13), and a transmit-side output HDMI/DVI connection (6). The receive module (2) comprises a receive-side input HDMI/DVI connection (7), a high-speed block (10), a low-speed block (12), a DC block (14), and a receive-side output HDMI/DVI connection (8). Either or both of the transmit module and receive module may have a DC-in (24) connection to permit external power to be applied thereto. Alternatively, or in addition, power may be drawn from the source or sink device where expanded specification of future source/sink HDMI power exists.

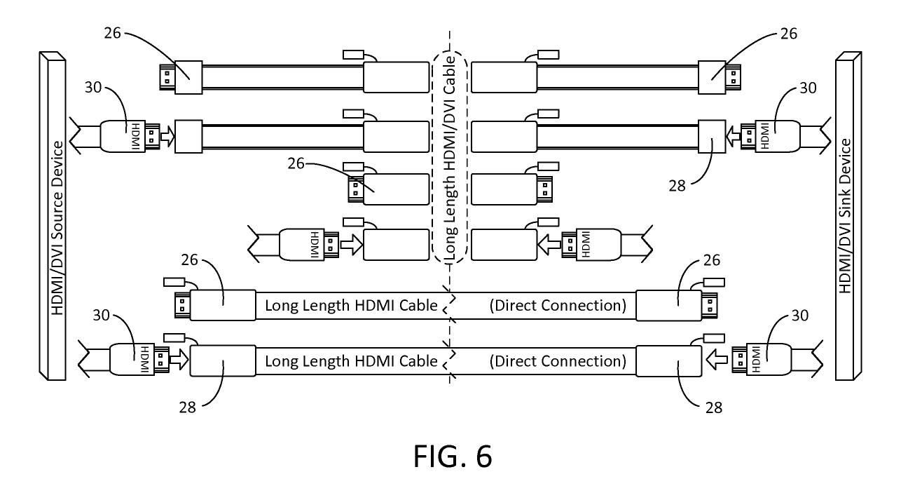

The HDMI/DVI connections (5, 6, 7 and 8) may be any combination of A, B, C, D or E type HDMI male (26) or female (28), examples of which are shown in FIG. 6. Further, the transmit module and receive module may be linked by a separately provided long reach HDMI/DVI cable, or could be permanently linked by an integral (e.g., direct solder) HDMI/DVI cable. The transmit module and receive module may further be linked to the source and sink devices by separate patch cables (30).

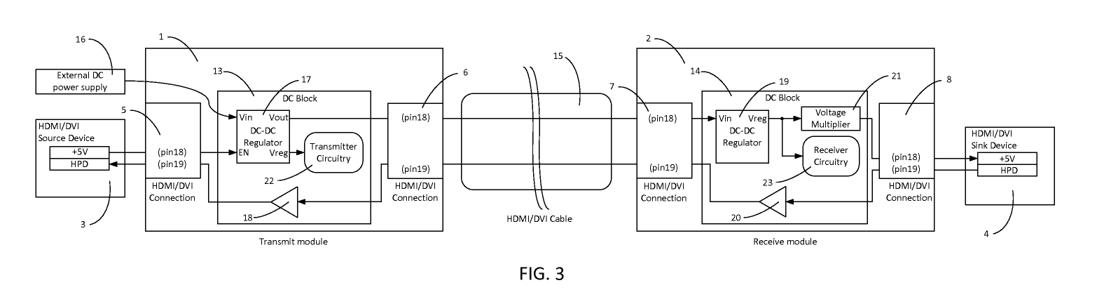

Referring to FIG. 3, operation of the DC block is now described. The +5V signal within an HDMI/DVI cable (pin 18) indicate presence of an HDMI source to a sink device. Compliant devices currently are not permitted to draw more than 55 mA from the +5V signal, however a long reach HDMI/DVI cable may experience signal loss requiring greater than 55 mA to be provided by the source device to be detected by the sink device. A draw of greater than 55 mA from the source device could cause damage if it was designed to rely on compliance.

The DC block (13) described herein enables the sink device to detect the +5V signal provided by the source device and for the source device to detect the Hot Plug Detect (HPD) signal returned from the sink device, even over a long reach HDMI/DVI cable.

An example transmit module (1) comprises a transmit-side input HDMI/DVI connection (5) linking the transmit module (1) to an HDMI/DVI source device (3). The DC block (13) of the transmit module (1) shown further comprises a transmit-side DC-DC regulator (17), transmitter circuitry (22), a transmit-side HPD buffer (18) and a transmit-side output HDMI/DVI connection (6). The transmitter circuitry (22) comprises the high speed block, low speed block and related circuitry to enable the foregoing.

A corresponding receive module (2) comprises a receive-side output HDMI/DVI connection (8) linking the receive module (2) to an HDMI/DVI sink device (4). The receive module (2) further comprises a receive-side input HDMI/DVI connection (7) and DC block (14) which comprises a receive-side DC-DC regulator (19), receiver circuitry (23), a voltage multiplier (21) and a receive-side HPD Buffer (20). The receiver circuitry (23) comprises high speed block, low speed block and related circuitry to enable the foregoing.

The transmit module (1) and receive module (2) are shown connected by an HDMI/DVI cable (15) which could be long reach. In the example shown, the transmit module (1) is shown linked to an external DC power supply (16). The external DC power supply (16) could, however, be connected to the receive module (2) or both modules separately, with suitable modifications being made to the DC blocks as would be understood.

The DC-DC regulators (17, 19) may comprise a step-down DC voltage regulator having a Vout DC level and current rating sufficient to compensate for the resistive drop across the HDMI/DVI cable (15). In practice, the resistive drop may be about ˜0.25 ohms/m using 28AWG conductor, though other characteristics are contemplated. The DC-DC regulators (17, 19) may have a Vout between 4.7V and 5.3V output at 55 mA.

To enable the DC block to remain operative and reliable in the presence of a long range HDMI/DVI cable, the transmit module substitutes a regulated +5V signal from the externally supplied voltage for the +5V signal obtained from the HDMI/DVI source device (3). The +5V signal from the HDMI/DVI source device (3) is sent through the transmit-side input HDMI/DVI connection (5) and used as a logic enable bit to the transmit-side DC-DC regulator (17). When an external supply voltage from the external DC power supply (16) is present at the Vin of the transmit-side DC-DC regulator (17), a +5V signal from the HDMI/DVI source device (3) causes the transmit-side DC-DC regulator (17) to provide a regulated voltage (Vreg) to the transmitter circuitry (22) as well as an optional external supply voltage (Vout) to the downstream receive-side DC-DC regulator through pin18 of the HDMI/DVI cable (15). It should be understood that the downstream external supply voltage is not needed at the receive module if the receive module is powered independently.

When the receive-side DC-DC regulator (19) receives a +5V signal on its Vin (as supplied by the transmit module), it generates the nominal recommended voltage rail of the integrated circuits on Vreg to power the receiver circuitry (23) and voltage multiplier (21). The voltage multiplier (21) reasserts the DC supply to a compliant +5V signal to be provided to the HDMI/DVI sink device (4) through the transmit-side output HDMI/DVI connection (8).

The voltage multiplier (21) is configured to output a +5V signal at a voltage between 4.8 and 5.3V, with over-current protection less than 500 mA, and to supply a minimum of 55 mA to the HDMI/DVI sink device (4). A compliant HDMI/DVI sink device (4) receiving the +5V signal will enable its HPD signal, which is provided to the receive-side DC buffer (20). The receive-side DC buffer consequently sets its output signal to 3.3V. The output signal from the receive-side DC buffer (20) is transmitted by the HDMI/DVI cable (15) over pin 19 of the HDMI/DVI cable and input to the transmit-side DC buffer (18).

The transmit-side DC buffer is configured to output a signal within the compliant range of 2.0V to 5.3V required for compliant detection by the HDMI/DVI source device (3) when the HPD signal is received over pin 19 of the HDMI/DVI cable, and within the compliant range of 0V to 0.8V when the HPD signal is not received over pin 19 of the HDMI/DVI cable. In an example, the transmit-side DC buffer outputs a signal about 3.3V when the HPD signal is received and a signal of 0V when the HPD signal is not received. The regenerated HPD signal at the output of the transmit-side DC Buffer (18) is provided to the HDMI/DVI source device (3).

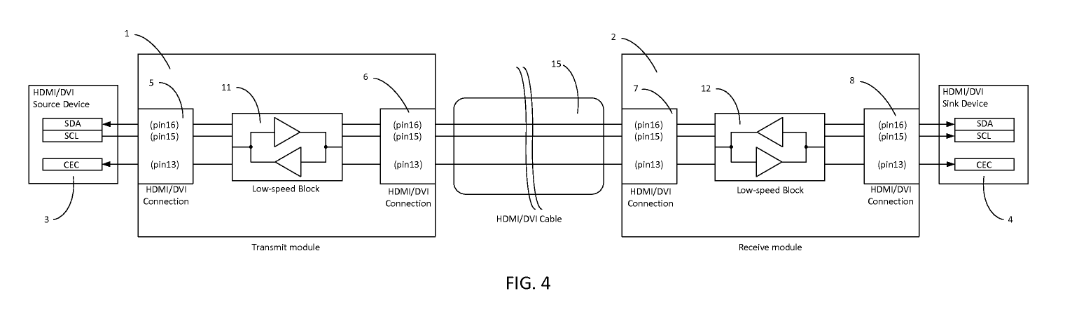

With reference now to FIG. 4, the HDMI/DVI low-speed block of a transmit-powered embodiment of the apparatus is shown. The low-speed block is associated with high definition content protection (HDCP), Extended Display Information Data (EDID) and Consumer Electronics Control (CEC).

HDCP is used to ensure legal content is continuously being delivered (at up to 100 kHz) over the HDMI/DVI cable. HDCP errors manifest in periodic white screen flashing (pseudo random noise), OSD error messages and loss of signal. HDCP operates over the SDA and SCL wires (pins 16 and 15, respectively). In typical installations, the wires are between 28AWG and 32AWG and are characterized by excessively high capacitance, which often exceeds the compliant capacitance of 700 pF. Longer cables typically experience higher capacitance. Distortion of these signals can occur, particularly in longer cables, resulting in undesirable effects.

EDID is used by the sink device (e.g., the display) to describe its own capabilities to the source device to which it is connected. An EDID handshaking event occurs between the source and sink devices on initial connection or physical reconnection. EDID operates at the same data rate as HDCP and EDID errors manifest in similar effects as HDCP errors.

CEC enables a user to control one device through another connected device. CEC communication occurs bidirectionally over the CEC wire (pin 13). CEC errors may not be as catastrophic as HDCP or EDID errors, but CEC has become a highly desired feature and its accurate operation may be relied upon by a user.

As shown in FIG. 4, the transmit module (1) again comprises the transmit-side input HDMI/DVI connection (5) linking the transmit module (1) to an HDMI/DVI source device (3). The low-speed block (11) comprises a transmit-side low-speed buffer linking the transmit-side input HDMI/DVI connection (5) and the transmit-side output HDMI/DVI connection (6).

The corresponding receive module (2) again comprises a receive-side output HDMI/DVI connection (8) linking the receive module (2) to an HDMI/DVI sink device (4). The receive module (2) again comprises a receive-side input HDMI/DVI connection (7). The transmit module (1) and receive module (2) are shown connected by an HDMI/DVI cable (15) which could be long reach. The receive module has a low-speed block (12) comprises a receive-side low-speed buffer linking the receive-side input HDMI/DVI connection (7) to the receive-side output HDMI/DVI connection (8).

In use, SDA/SCL communication signals sent by the HDMI/DVI source device (3) and HDMI/DVI sink device (4) are provided to the transmit-side HDMI/DVI low-speed buffer and the receive-side HDMI/DVI low-speed buffer, respectively. Each of the transmit-side and receive-side HDMI/DVI low-speed buffers isolates any excessive capacitance of the HDMI/DVI cable (15) and permits accelerated transient times to the HDMI/DVI source device (3) and HDMI/DVI sink device (4). This ensures that no data bits (up to 100 kHz) are lost or misinterpreted. A faster transient (or rise/fall time) will ensure the SDA/SCL signals will meet the proper supply rail voltage threshold. The buffers are configured to provide SDA/SCL signals having a maximum 1 us rise time as per I2C-bus standard-mode specification.

The CEC (Consumer Electronics Control) signal is communicated bi-directionally at 1 kbps via pin 13 of the HDMI/DVI cable (15) and is similarly provided to the transmit-side HDMI/DVI low-speed buffer and receive-side HDMI/DVI low-speed buffer to prevent loss or misinterpretation.

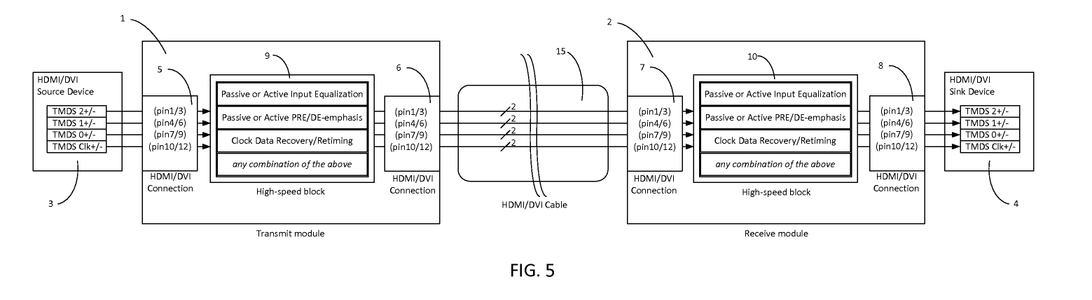

With reference to FIG. 5, the HDMI/DVI high speed block of a transmit powered embodiment of the apparatus is shown. The high speed block handles TMDS signals. Compliance requires less than 0.3UI high-speed jitter. Typically, longer cables cause higher jitter.

The transmit module (1) again comprises the transmit-side input HDMI/DVI connection (5) linking the transmit module (1) to an HDMI/DVI source device (3). The high-speed block (9) comprises an HDMI/DVI TMDS transmitter (9) linking the transmit-side input HDMI/DVI connection (5) and the transmit-side output HDMI/DVI connection (6).

The corresponding receive module (2) again comprises a receive-side output HDMI/DVI connection (8) linking the receive module (2) to an HDMI/DVI sink device (4). The receive module (2) again comprises a receive-side input HDMI/DVI connection (7). The transmit module (1) and receive module (2) are shown connected by an HDMI/DVI cable (15) which could be long reach. The receive module (2) comprises an HDMI/DVI TMDS receiver (10) linking the receive-side input HDMI/DVI connection (7) to the receive-side output HDMI/DVI connection (8).

High-speed data from the HDMI/DVI source (3) is provided to the HDMI/DVI TMDS transmitter (9), which then sends the data downstream to the HDMI/DVI TMDS receiver (10) through the HDMI/DVI cable (15). The HDMI/DVI TMDS transmitter (9) and HDMI/DVI TMDS receiver (10) both implement signal conditioning techniques such that high-speed signal intervention is provided at both ends of the native HDMI/DVI cable. Examples of the signal conditioning techniques include: (a) passive or active input equalization; (b) passive or active pre/de-emphasis; (c) clock data recovery/retiming; and combinations thereof.

It will be appreciated that while these techniques may be recognized in the art, the present apparatus implements them at both ends of the native HDMI/DVI cable.

At the transmit end, the HDMI/DVI TMDS transmitter (9) may provide direct (passive) high-speed TMDS, such that on the receive end intervention is only for signal recovery. The HDMI/DVI TMDS transmitter (9) may further provide passive (using RLC components) or active input equalization to compensate for the short length HDMI interconnect cable loss from the HDMI/DVI source (3) to the transmit module (1). Active input equalization may be fixed or adaptive. Passive (using RLC components) or active output pre-emphasis may boost specific targeted frequencies to pre-compensate for losses over the HDMI/DVI cable (15). For example, a boost of about 3 to 9 dB may be provided at approximately 1.7 GHz for 4K 24 fps. Passive (using RLC components) or active output de-emphasis may similarly boost specific targeted frequencies as a means of pre-compensating for losses over the HDMI/DVI cable (15). For example, a boost of about −3 to −9 dB may be provided at approximately 1.7 GHz for 4K 24 fps.

An active CDR (Clock Data Recovery) or retiming device may reduce HDMI/DVI source device (3) launch signal jitter, thereby resetting the jitter budget before reaching the HDMI/DVI Cable (15). Resetting of the jitter budget may comprise retiming the source jitter. For example, if the HDMI source device is 0.3UI as per specification (30% eye closing) the jitter may be reset as low as 0.05 (5%) depending on the quality of CDR being used.

Any combination of the foregoing signal integrity techniques may be used in conjunction to increase overall cable reach capabilities.

At the receive end, the HDMI/DVI TMDS receiver (10) may provide passive (using RLC components) or active input equalization to compensate for the loss of the HDMI/DVI cable (15). The applied equalization gain should match the inverse of the cable loss associated with the HDMI/DVI cable (15).

An active CDR (Clock Data Recovery) or retiming device in the receiver module (2) may comprise a PLL circuit to reset the jitter budget of the incoming signal. Resetting the jitter budget may comprise retiming the equalized signal on the receiver module (2) via the HDMI/DVI cable (15), which may be approximately 0.3UI to 0.7UI, to as low as 0.05UI (5% eye closure) depending on the quality of CDR being used directly to the HDMI/DVI sink device (4). The CDR stage may ensure that the end signal exceeds IJT (Input Jitter Tolerance) limits due to the accumulation of jitter between the HDMI/DVI TMDS transmitter and HDMI/DVI TMDS receiver.

Any combination of the foregoing signal integrity techniques may be used in conjunction to increase overall cable reach capabilities.

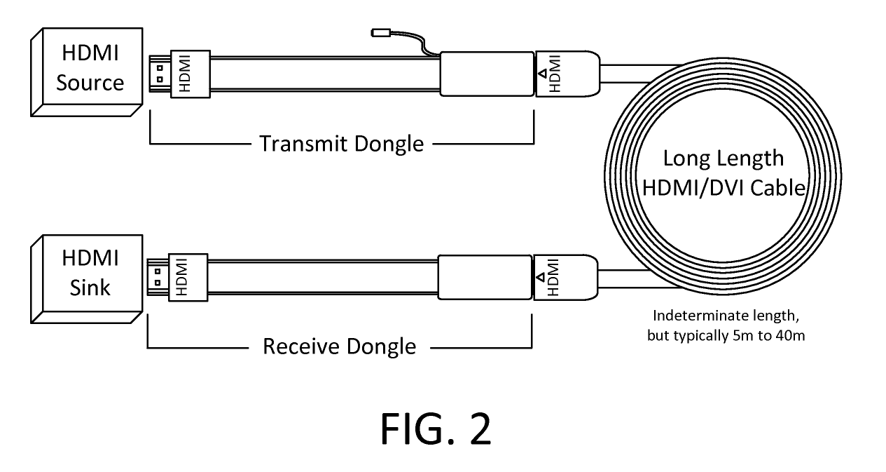

The apparatus described herein may be provided as an add-on component to be coupled to an existing HDMI/DVI cable, as seen in FIG. 2, for example, or could include an integral HDMI/DVI cable. Various embodiments are shown in FIG. 6, the transmit module and/or receive module could further be built into HDMI/DVI source and/or sink devices.

The apparatus described may be applied to enable an increase in cable length and/or use of finer gauge cables (e.g., for easier in-wall installation).

The approaches described herein may be applied to long reach applications for specifications other than HDMI/DVI, including for example: DisplayPort™, Thunderbolt™, USB 3.0 and Firewire.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

We claim:

1. An apparatus for extending HDMI/DV signal transmission, said apparatus comprising:
(a) a transmit module comprising a transmit-side DC block, a transmit-side high speed block and a transmit-side low speed block, said transmit module capable of being coupled to an HDMI source device and communicating therewith in compliance with the HDMI specification; and
(b) a receive module comprising a receive-side DC block, a receive-side high speed block and a receive-side low speed block, said receive module capable of being coupled to an HDMI sink device and communicating therewith in compliance with the HDMI specification;
said transmit module and receive module capable of being coupled to one another and communicating with one another to mitigate effects of long reach HDMI cabling.

2. The apparatus of claim 1, wherein said transmit-side DC block comprises a voltage regulator operable to output a high-current signal upon receiving a complaint +5V signal from said HDMI source device.

3. The apparatus of claim 2, wherein said voltage regulator is a step-down DC voltage regulator having a Vout DC level and current rating sufficient to compensate for a resistive drop across said HDMI cabling.

4. The apparatus of claim 2, wherein upon receiving said high-current signal, said receive-side DC block reasserts a compliant +5V signal for said HDMI sink device.

5. The apparatus of claim 2, wherein said receive-side DC block comprises a DC buffer for outputting a signal to said transmit module in response to receiving an HPD signal from said sink device.

6. The apparatus of claim 1, wherein said transmit-side low-speed block comprises a transmit-side low-speed buffer and said receive-side low-speed block comprises a receive-side low-speed buffer.

7. The apparatus of claim 6, wherein said transmit-side low-speed buffer and said receive-side low-speed buffer are operable to isolate excessive capacitance of said HDMI cabling.

8. The apparatus of claim 1, wherein said transmit-side high-speed block comprises a TMDS transmitter and said receive-side high-speed block comprises a TMDS receiver.

9. The apparatus of claim 8, wherein said TMDS transmitter and said TMDS receiver implement signal conditioning techniques.

10. The apparatus of claim 9, wherein said signal conditioning techniques comprise: passive input equalization, active input equalization, passive pre-emphasis, passive de-emphasis, active pre-emphasis, active de-emphasis, clock data recovery, clock data retiming, and any combination thereof.

11. A method for extending HDMI/DVI signal transmission, said method comprising enabling the isolation of DC, low-speed and high-speed signals of an HDMI cable using a transmit module coupled to a first end of said HDMI cable and a receive module coupled to a second end of said HDMI cable, said transmit module comprising a transmit-side DC block, a transmit-side high speed block and a transmit-side low speed block, said transmit module capable of being coupled to an HDMI source device and communicating therewith in compliance with the HDMI specification, and said receive module comprising a receive-side DC block, a receive-side high speed block and a receive-side low speed block, said receive module capable of being coupled to an HDMI sink device and communicating therewith in compliance with the HDMI specification; said transmit module and receive module mitigating effects of long reach HDMI cabling.

12. The method of claim 11, wherein said transmit-side DC block comprises a voltage regulator operable to output a high-current signal upon receiving a complaint +5V signal from said HDMI source device.

13. The method of claim 12, wherein said voltage regulator is a step-down DC voltage regulator having a Vout DC level and current rating sufficient to compensate for a resistive drop across said HDMI cabling.

14. The method of claim 12, wherein upon receiving said high-current signal, said receive-side DC block reasserts a compliant +5V signal for said HDMI sink device.

15. The method of claim 12, wherein said receive side DC block comprises a DC buffer for outputting a signal to said transmit module in response to receiving an HPD signal from said sink device.

16. The method of claim 11, wherein said transmit-side low-speed block comprises a transmit-side low-speed buffer and said receive-side low-speed block comprises a receive-side low-speed buffer.

17. The method of claim 16, wherein said transmit-side low-speed buffer and said receive-side low-speed buffer are operable to isolate excessive capacitance of said HDMI cabling.

18. The method of claim 11, wherein said transmit-side high-speed block comprises a TMDS transmitter and said receive-side high-speed block comprises a TMDS receiver.

19. The method of claim 18, wherein said TMDS transmitter and said TMDS receiver implement signal conditioning techniques.

20. The method of claim 19, wherein said signal conditioning techniques comprise: passive input equalization, active input equalization, passive pre-emphasis, passive de-emphasis, active pre-emphasis, active de-emphasis, clock data recovery, clock data retiming, and any combination thereof.
